(19) United States
(12) Patent Application Publication
(10) Pub. No.: US 2022/0064392 A1
(43) Pub. Date: Mar. 3, 2022

(54) ANTISTATIC POLYESTER FILM AND ANTISTATIC COATING LIQUID

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); CHENG-HUNG CHEN, TAIPEI (TW)

(21) Appl. No.: 17/341,391

(22) Filed: Jun. 8, 2021

(30) Foreign Application Priority Data
Aug. 31, 2020 (TW) 109129692

(51) Int. Cl. C08J 7/044; C08J 7/04; C08K 3/04; C08K 3/36; C08K 5/00; C08G 63/183

(52) U.S. Cl. CPC C08J 7/044; C08J 7/042; C08K 3/041; C08K 3/36; C08G 2150/00; C08G 63/183; C08J 2367/02; C08K 2201/001; C08K 5/0025

(57) ABSTRACT

An antistatic polyester film and an antistatic coating liquid are provided. The antistatic polyester film includes a polyester substrate and an antistatic coating layer formed on the antistatic polyester film. The antistatic coating layer is formed by applying an antistatic coating liquid on the side surface of the polyester substrate by an in-line coating, and drying the antistatic coating liquid. The antistatic coating liquid includes an aqueous solvent, a conductive additive, and a water soluble polyester resin. Based on a total weight of the antistatic coating liquid being 100 wt %, the aqueous solvent ranges between 50 wt % and 85 wt %, the conductive additive ranges between 1 wt % and 20 wt %, and the water soluble polyester resin ranges between 2 wt % and 40 wt %.

### CROSS-REFERENCE TO RELATED PATENT APPLICATION

This application claims the benefit of priority to Taiwan Patent Application No. 109129692, filed on Aug. 31, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester film, and more particularly to an antistatic polyester film and an antistatic coating liquid.

### BACKGROUND OF THE DISCLOSURE

In order to enable a surface of a polyester film to have antistatic properties, most conventional surface treatments include performing a corona treatment on the surface of the polyester film before applying an antistatic coating liquid on the surface of the polyester film by an off-line coating (OLC).

However, the conventional surface treatment mentioned above may lead to many problems, for example: 1. two processing procedures, including corona treatment and off-line coating, are required in the surface treatment, so that the manufacturing cost is increased; 2. when the electrically conductive material has poor dispersion in the antistatic coating liquid, the surface of the polyester film does not have antistatic and antifouling properties; 3. when an antistatic coating layer has insufficient thickness, the surface of the polyester film does not have antistatic and antifouling properties; 4. when the power of corona treatment is insufficient, the bonding strength between the polyester film substrate and the antistatic coating is insufficient.

In another aspect, corona treatment of high strength is usually applied to the surface of the polyester film in most of the conventional surface treatments mentioned above and damages the surface structure of the polyester film to improve the bonding strength between a polyester film substrate and the antistatic coating layer. Subsequently, the off-line coating may provide antistatic property to the surface of the polyester film. However, if the conductive material in the antistatic coating liquid has poor dispersion in the organic resin, the polyester film will have poor antistatic and antifouling properties. Moreover, the off-line coating has a higher cost.

### SUMMARY OF THE DISCLOSURE

In response to the above-referenced technical inadequacies, the present disclosure provides an antistatic polyester film and an antistatic coating liquid.

In one aspect, the present disclosure provides an antistatic polyester film that includes a polyester substrate and an antistatic coating layer formed on the antistatic polyester film. The antistatic coating layer is formed by applying an antistatic coating liquid on the side surface of the polyester substrate by an in-line coating, and drying the antistatic coating liquid. Based on a total weight of the antistatic coating liquid being 100 wt %, the antistatic coating liquid includes an aqueous solvent ranging between 50 wt % and 85 wt %, a conductive additive ranging between 1 wt % and 20 wt %, and a water soluble polyester resin ranging between 2 wt % and 40 wt %.

Preferably, the antistatic polyester film is a biaxially oriented polyethylene terephthalate (BOPET) film, and after extension, the polyester substrate has a thickness between 50 μm and 350 μm, and the antistatic coating layer has a thickness between 0.05 μm and 0.5 μm.

Preferably, the antistatic coating liquid further includes a cross-linking agent. Based on a total weight of the antistatic coating liquid being 100 wt %, the cross-linking agent ranges between 0.1 wt % and 20 wt %. The cross-linking agent is a polyester cross-linking agent.

Preferably, the antistatic coating liquid further includes a filler particle mixture. Based on a total weight of the antistatic coating liquid being 100 wt %, the filler particle mixture ranges between 0.05 wt % and 10 wt %. The filler particle mixture includes silicon dioxide.

Preferably, the antistatic coating liquid further includes an auxiliary additive. Based on a total weight of the antistatic coating liquid being 100 wt %, the auxiliary additive ranges between 0.05 wt % and 10 wt %. The auxiliary additive is at least one of a dispersant, an anti-foaming agent, and a wetting agent.

Preferably, the conductive additive is at least one of a conductive polymer and a carbon nanotube.

Preferably, the polyester substrate includes a first polyester resin layer and two second polyester resin layers. The first polyester resin layer includes a polyester resin and inorganic particles. Based on a total weight of the first polyester resin layer being 100 wt %, the polyester resin ranges between 50 wt % and 95 wt %, and the inorganic particles range between 5 wt % and 50 wt %.

Preferably, the first polyester resin layer has two surfaces opposite to each other, the two second polyester resin layers are respectively formed on the two surfaces of the first polyester resin layer, and each of the second polyester resin layers includes a polyester resin and inorganic particles. Based on a total weight of the second polyester resin layer being 100 wt %, the polyester resin ranges between 50 wt % and 95 wt %, and the inorganic particles range between 5 wt % and 50 wt %. The antistatic coating layer is formed on a side surface of at least one of the second polyester resin layers that is away from the first polyester layer.

Preferably, after extension, the first polyester resin layer has a thickness between 50 μm and 300 μm, and each of the second polyester resin layers has a thickness between 1 μm and 50 μm.

In another aspect, the present disclosure provides an antistatic coating liquid. Based on a total weight of the antistatic coating liquid being 100 wt %, the antistatic coating liquid includes an aqueous solvent ranging between 50 wt % and 85 wt %, a conductive additive ranging between 1 wt % and 20 wt %, and a water soluble polyester resin ranging between 2 wt % and 40 wt %.

Therefore, by virtue of “an antistatic coating layer formed on a side surface of the polyester substrate; the antistatic coating layer is formed by applying an antistatic coating liquid on the side surface of the polyester substrate by an in-line coating, and drying the antistatic coating liquid” and “based on a total weight of the antistatic coating liquid being 100 wt %, the antistatic coating liquid including an aqueous solvent ranging between 50 wt % and 85 wt %; a conductive additive ranging between 1 wt % and 20 wt %; and a water soluble polyester resin ranging between 2 wt % and 40 wt %”, the antistatic polyester film has excellent antistatic property, adhesion strength, high light transmittance, and low haze. Moreover, since the antistatic coating liquid can be applied on the polyester substrate by an in-line coating, the manufacturing cost of the antistatic polyester film can be effectively reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic side view of an antistatic polyester film according to an embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### Antistatic Polyester Film

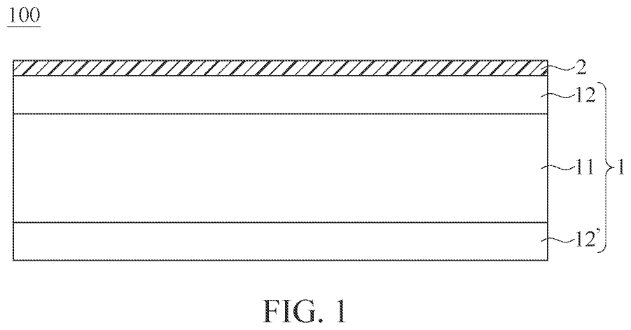

Referring to FIG. 1, an embodiment of the present disclosure provides an antistatic polyester film 100. The antistatic polyester film 100 has excellent antistatic properties, adhesion strength, high light transmittance, and low haze. The antistatic polyester film 100 can be applied to a substrate of an optoelectronic product, or can be applied to a protective film of an electronic component or a protective film of a panel.

In order to achieve the above objectives, the antistatic polyester film 100 includes a polyester substrate 1 and an antistatic coating layer 2, and the antistatic coating layer 2 is formed on a side surface of the polyester substrate 1. The antistatic coating layer 2 is applied on the side surface of the polyester substrate 1 by an in-line coating (ILC), then the antistatic coating liquid is dried to form the antistatic coating layer 2.

The polyester substrate 1 includes inorganic particles, so that the surface of the antistatic polyester film 100 has a certain roughness. That is to say, the roughness of the surface can provide an anti-adhesion effect when the antistatic polyester film 100 is wound up. The inorganic particles can be, for example, at least one material selected from the group consisting of silicon dioxide, calcium carbonate, calcium phosphate, barium sulfate, and kaolinite. Generally, the particle size of the inorganic particles is between 1 and 10 micrometers. However, the present disclosure is not limited thereto.

More specifically, in the present embodiment, the polyester substrate 1 includes a first polyester resin layer 11 and two second polyester resin layers 12, 12′.

The first polyester resin layer 11 includes a polyester resin and inorganic particles. The polyester resin is a matrix material of the first polyester resin layer 11, and the inorganic particles are an additional material of the first polyester resin layer 11. In the present embodiment, based on a total weight of the first polyester resin layer being 100 wt %, the polyester resin ranges between 50 wt % and 95 wt %, the inorganic particles range between 5 wt % and 50 wt %.

The first polyester resin layer 11 has two surfaces opposite to each other, and the two second polyester resin layers 12, 12′ are respectively formed on the two surfaces of the first polyester resin layer 11. Each of the second polyester resin layer 12 or 12′ includes a polyester resin and inorganic particles mentioned above. The polyester resin is a matrix material of the second polyester resin layers 12, 12′, and the inorganic particles are an additional material of the second polyester resin layers 12, 12′. In the present embodiment, based on a total weight of the second polyester resin layer 12, 12′ being 100 wt %, the polyester resin ranges between 50 wt % and 95 wt %, and the inorganic particles range between 5 wt % and 50 wt %.

The antistatic coating layer 2 is formed on a side surface of at least one of the second polyester resin layers 12, 12′ that is away from the first polyester layer 11. More specifically, the antistatic coating layer 2 is formed by applying an antistatic coating liquid on a side surface of at least one of the two second polyester resin layers 12, 12′ by an in-line coating, and drying the antistatic coating liquid, so that the antistatic coating liquid is formed into the antistatic coating layer 2.

It should be noted that, although the polyester substrate 1 is exemplified as having a three-layered structure including a first polyester layer 11 and two second polyester resin layers 12, 12′in the present embodiment, the present disclosure is not limited thereto. The structure of the polyester substrate 1 can be designed as a single layer, double layer, or more than four layers, according to the requirements of product design.

More specifically, the antistatic polyester film of the present embodiment is a biaxially oriented polyethylene terephthalate (BOPET) film After extension, the polyester substrate has a thickness between 50 μm and 350 μm, and the antistatic coating layer has a thickness between 0.05 μm and 0.5 μm.

Further, after extension, the first polyester resin layer 11 has a thickness between 50 μm and 300 μm, and the second polyester resin layers 12, 12′ each have a thickness between 1 μm and 50 μm in the polyester substrate 1.

In order to provide antifouling and antistatic effects as well as desired optical characteristics to the antistatic polyester film 100, the key technological feature of the present disclosure is to control the dispersity of the conductive material of the antistatic coating liquid in the organic resin composition, so that the surface of the polyester film 100 can achieve a target impedance value (e.g., smaller than 1.0 E+10 Ω). The sequence of adding resin and the conductive material to the antistatic coating liquid can prevent the conductive material from agglomeration. The surface of the conductive material is modified such that the conductive material can be evenly dispersed in the resin.

Moreover, the antistatic polyester film 100 can have both bonding strength and antifouling effects (e.g., the contact angle of water being greater than 90°), and the antistatic polyester film 100 can still retain high light transmittance and low haze characteristics of the polyester film itself

More specifically, due to the composition of the antistatic coating liquid, the antistatic coating liquid provided in the present embodiment can be applied on the polyester substrate 1 by an in-line coating, so as to form an antistatic coating layer 2 with both the bonding strength and antifouling effects.

In addition, the antistatic coating layer 2 does not affect the optical characteristic of the polyester substrate 1. Therefore, the antistatic polyester film 100 can still retain the high light transmittance and low haze characteristics.

The composition of the antistatic coating liquid includes an aqueous solvent, a conductive additive, and a water soluble polyester resin. The conductive additive is at least one of a conductive polymer and a carbon nanotube. Moreover, the conductive polymer can be, for example, poly(3,4-ethylenedioxythiophene) (PEDOT), polypyrrole (PPY), polyaniline (PANI), polythiophene (PT), or poly(p-phenylene sulfide) (PPS), etc.

Based on a total weight of the antistatic coating liquid being 100 wt %, the aqueous solvent ranges between 50 wt % and 85 wt %. Preferably, the aqueous solvent ranges between 55 wt % and 80 wt %. Most preferably, the aqueous solvent ranges between 60 wt % and 75 wt %.

In the antistatic coating liquid, based on a total weight of the antistatic coating liquid being 100 wt %, the conductive additive ranges between 1 wt % and 20 wt %. Preferably, the conductive additive ranges between 2 wt % and 18 wt %. Most preferably, the conductive additive ranges between 5 wt % and 15 wt %. The conductive additive has light shielding property, so that it is inappropriate for the conductive additive to have a high concentration.

In the antistatic coating liquid, based on a total weight of the antistatic coating liquid being 100 wt %, the water soluble polyester resin ranges between 2 wt % and 40 wt %. Preferably, the water soluble polyester resin ranges between 5 wt % and 30 wt %. Most preferably, the water soluble polyester resin ranges between 10 wt % and 20 wt %.

According to the composition mentioned above, the antistatic coating liquid can be applied on the polyester substrate 1 by an in-line coating.

It is worth mentioning that, in the present embodiment, the water soluble polyester resin in the antistatic coating liquid has a certain extensibility (also called tensile property), and the water soluble polyester resin has a certain impedance value after extension.

Moreover, in the in-line coating process, the polyester substrate is stretched in a longitudinal direction (i.e., an MD direction). Next, the antistatic coating liquid is applied on the polyester substrate which is stretched in the longitudinal direction. Then the polyester substrate and the antistatic coating liquid are stretched in a transverse direction (i.e., a TD direction), and the antistatic coating liquid is dried during transverse direction stretching, so that the antistatic coating liquid is formed into the antistatic coating layer.

In the present embodiment, during the drying process, most liquid components (e.g., water) in the antistatic coating liquid are removed, and only a small part of the solid components are left. Taking 100 g of the antistatic coating liquid as an example, approximately 80 g to 95 g of liquid components in the antistatic coating liquid are removed while approximately 5 g to 20 g of the solid components in the antistatic coating liquid are left, and the antistatic coating layer is formed. However, the present disclosure is not limited thereto.

The antistatic polyester film in the present embodiment includes an antistatic coating layer 2 with bonding strength and antifouling effect. The antistatic coating layer 2 is formed by an in-line coating. Therefore, the surface of the antistatic polyester film in the present embodiment does not require corona treatment.

In one embodiment of the present disclosure, the antistatic coating liquid further includes a cross-linking agent. Based on a total weight of the antistatic coating liquid being 100 wt %, the cross-linking agent ranges between 0.1 wt % and 20 wt %. Moreover, the cross-linking agent is a polyester cross-linking agent, which allows the water soluble polyester resin to have a cross-linking reaction.

In one embodiment of the present disclosure, the antistatic coating liquid further includes a filler particle mixture. Based on a total weight of the antistatic coating liquid being 100 wt %, the filler particle mixture ranges between 0.05 wt % and 10 wt %. Moreover, the filler particle mixture includes silicon dioxide and water. The silicon dioxide is used as a slipping agent.

In one embodiment of the present disclosure, the antistatic coating liquid further includes an auxiliary additive. Based on a total weight of the antistatic coating liquid being 100 wt %, the auxiliary additive ranges between 0.05 wt % and 10 wt %. The auxiliary additive is at least one of a dispersant, an anti-foaming agent, and a wetting agent.

### Experimental Results

Exemplary examples 1 to 5 and comparative examples 1 to 3 are described herein. However, the exemplary examples are only used to help understand the present disclosure, and the scope of the present disclosure is not limited to these examples.

Exemplary example 1: A water soluble coating liquid having 60 wt % of aqueous solvent, 20 wt % of water soluble polyester resin, 5 wt % of auxiliary additive, 2 wt % of polyester cross-linking agent, and 8 wt % of filler particle mixture is prepared. To complete the preparation of the antistatic coating liquid, 5 wt % of conductive additive is added into the water soluble coating liquid. During the in-line coating (ILC) process, the antistatic coating liquid is applied on the surface of the polyester (PET) substrate by using a wire bar. To complete the preparation of the antistatic polyester film, the antistatic coating liquid is dried to form the antistatic coating layer on the polyester substrate. The antistatic polyester film is a biaxially oriented polyethylene terephthalate (BOPET) film. The antistatic polyester films is subjected to physicochemical property tests, such as impedance value (Ω), cross cut adhesion test (OB-5B), light transmittance (%), haze (%), and water contact angle (°).

The antistatic polyester film of the exemplary examples 2 to 5 can be produced and tested in the same manner as that of the exemplary example 1. The compositions of the antistatic coating liquid are different among the exemplary examples 1 to 5. The compositions of the antistatic coating liquid in the exemplary examples 1 to 5 are as shown in Table 1 below. The physicochemical property tests results of the exemplary examples 1 to 5 are as shown in Table 1 below.

Comparative example 1: A water soluble coating liquid having 64 wt % of aqueous solvent, 20 wt % water soluble polyester resin, 5 wt % of auxiliary additive, 2 wt % of polyester cross-linking agent, and 8 wt % of filler particle mixture is prepared. To complete the preparation of the antistatic coating liquid, 1 wt % of conductive additive is added into the water soluble coating liquid (the content is less than exemplary examples 1). During the in-line coating (ILC) process, the antistatic coating liquid is applied on the surface of the polyester (PET) substrate by a wire bar. To complete the preparation of the antistatic polyester film, the antistatic coating liquid is dried to form the antistatic coating layer on the polyester substrate. The antistatic polyester film is a biaxially oriented polyethylene terephthalate (BOPET) film. The antistatic polyester film is subjected to physicochemical property tests, such as impedance value (Ω), cross cut adhesion test (OB-5B), light transmittance (%), haze (%), and water contact angle (°).

The antistatic polyester film of the comparative examples 2 and 3 can be produced and tested in the same manner as that of the comparative example 1. The compositions of the antistatic coating liquid are different among the comparative examples 1 to 3. The compositions of the antistatic coating liquid in the comparative examples 1 to 3 are as shown in Table 1 below. The physicochemical property test results of the comparative examples 1 to 3 are as shown in Table 1 below.

The relevant tests are described below, and the relevant test results are shown in Table 1 below.

Impedance value (Ω): the surface impedance of the polyester film is tested by ESD resistance tester.

Cross cut adhesion test (OB-5B): the adhesion strength between the antistatic coating layer and the polyester substrate is tested by cross cut adhesion test. The evaluation method is to observe the detached squares of the lattices (5B being the best, and 0B being the worst).

Light transmittance (%): the light transmittance of the polyester film is tested by transmissivity and haze tester.

Haze (%): the haze of the polyester film is tested by transmissivity and haze tester.

Water contact angle (°): the water contact angle of the polyester film is tested by contact angle meter. The water contact angle is used to evaluate the antifouling effect of the surface of the antistatic polyester film The water contact angle greater than 90° indicates that the surface of the antistatic polyester film has antifouling effect.

Table 1 shows the experimental conditions and test results.

TABLE 1

| | | Exemplary | Exemplary | Exemplary | Exemplary | Exemplary | Comparative | Comparative | Comparative |
|---|---|---|---|---|---|---|---|---|---|
| Terms | | example 1 | example 2 | example 3 | example 4 | example 5 | example 1 | example 2 | example 3 |
| Antistatic | Aqueous solvent (wt %) | 60 | 55 | 50 | 55 | 55 | 64 | 40 | 55 |
| coating | Conductive additive (wt %) | 5 | 10 | 15 | 10 | 10 | 1 | 25 | 10 |
| liquid | Water soluble polyester | 20 | 20 | 20 | 20 | 20 | 20 | 20 | 20 |
| | resin (wt %) | | | | | | | | |
| | Polyester cross-linking | 2 | 2 | 2 | 2 | 2 | 2 | 2 | 2 |
| | agent (wt %) | | | | | | | | |
| | Filler particle mixture (wt %) | 8 | 8 | 8 | 8 | 8 | 8 | 8 | 8 |
| | Auxiliary additive (wt %) | 5 | 5 | 5 | 5 | 5 | 5 | 5 | 5 |
| Polyester | Thickness of polyester substrate | 75 | 75 | 75 | 75 | 75 | 75 | 75 | 75 |
| film | (μm) | | | | | | | | |
| | Thickness of antistatic coating | 0.12 | 0.12 | 0.12 | 0.10 | 0.08 | 0.12 | 0.12 | 0.05 |
| | layer (μm) | | | | | | | | |
| Test | Impedance value (Ω) | 9.3E+08 | 2.5E+07 | 4.0E+06 | 1.2E+08 | 6.2E+08 | 8.5E+12 | 2.5E+04 | 3.3E+11 |
| results | Cross cut adhesion test (0B-5B) | 5B | 5B | 5B | 5B | 5B | 5B | 4B | 2B |
| | Light transmittance (%) | 89.9 | 89.5 | 89.8 | 89.3 | 89.6 | 89.6 | 88.8 | 89.9 |
| | Haze (%) | 4.55 | 4.92 | 5.15 | 4.75 | 4.68 | 4.05 | 12.05 | 4.58 |
| | Water contact angle (°) | 102 | 98 | 96 | 95 | 92 | 96 | 94 | 76 |

### Discussion of Test Results

Since the antistatic coating liquid of the exemplary examples 1 to 5 have an appropriate amount of the conductive additive (5 wt % to 15 wt %), the polyester film can maintain a desired target impedance value (e.g., smaller than 1.0E+10Ω) and haze range (e.g., a haze between 4% and 6%) after biaxial stretching.

Since the antistatic coating liquid of the comparative example 1 has insufficient conductive additives (having only 1 wt %), the conductive additives are dispersed in the antistatic polyester film after biaxial stretching. Therefore, the distances between each of the conductive additives are too far to form a conductive path, such that the impedance value exceeds a limit

Since the antistatic coating liquid of the comparative example 2 has excessive conductive additives (i.e., higher than 20 wt %), the polyester film has a low impedance value after biaxial stretching. Therefore, the light transmittance of the polyester film is decreased, and the haze of the polyester film is increased. The adhesion strength between the antistatic coating layer and the polyester substrate is poor (a result of the cross cut adhesion test being only 4B).

Since the thickness of the antistatic coating layer tends to be thin (being only 0.5 μm), the polyester film does not have an impedance effect after biaxial stretching. In the comparative example 3, the insufficient thickness of the antistatic coating layer leads to a poor adhesion strength between the antistatic coating layer and the polyester substrate (a result of the cross cut adhesion test being only 2B). The water contact angle of comparative example 3 is less than 90°, such that the polyester film has a poor antifouling effect.

### Beneficial Effects of the Embodiments

In conclusion, the antistatic polyester film and the antistatic coating liquid of the present embodiment allow the antistatic polyester film to have excellent antistatic property, adhesion strength, high light transmittance, and low haze through the technical solutions of “an antistatic coating layer formed on a side surface of the polyester substrate; an antistatic coating liquid being applied on the side surface of the polyester substrate by an in-line coating, and the antistatic coating liquid being dried to form the antistatic coating layer” and “based on a total weight of the antistatic coating liquid being 100 wt %, the antistatic coating liquid including: an aqueous solvent ranging between 50 wt % and 85 wt %; a conductive additive ranging between 1 wt % and 20 wt %; and a water soluble polyester resin ranging between 2 wt % and 40 wt %.”

Moreover, since the antistatic coating liquid can be applied on the polyester substrate by an in-line coating, the manufacturing cost of the polyester film is reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antistatic polyester film, comprising:
a polyester substrate; and
an antistatic coating layer formed on a side surface of the polyester substrate; wherein the antistatic coating layer is formed by applying an antistatic coating liquid on the side surface of the polyester substrate by an in-line coating, and drying the antistatic coating liquid;
wherein, based on a total weight of the antistatic coating liquid being 100 wt %, the antistatic coating liquid includes:
an aqueous solvent ranging between 50 wt % and 85 wt %;
a conductive additive ranging between 1 wt % and 20 wt %; and
a water soluble polyester resin ranging between 2 wt % and 40 wt %.

2. The antistatic polyester film according to claim 1, wherein the antistatic polyester film is a biaxially oriented polyethylene terephthalate (BOPET) film, and after extension, the polyester substrate has a thickness between 50 μm and 350 μm, and the antistatic coating layer has a thickness between 0.05 μm and 0.5 μm.

3. The antistatic polyester film according to claim 1, wherein the antistatic coating liquid further includes: a cross-linking agent, wherein, based on a total weight of the antistatic coating liquid being 100 wt %, the cross-linking agent ranges between 0.1 wt % and 20 wt %, wherein the cross-linking agent is a polyester cross-linking agent.

4. The antistatic polyester film according to claim 1, wherein the antistatic coating liquid further includes: a filler particle mixture, wherein, based on a total weight of the antistatic coating liquid being 100 wt %, the filler particle mixture ranges between 0.05 wt % and 10 wt %; wherein the filler particle mixture includes silicon dioxide.

5. The antistatic polyester film according to claim 1, wherein the antistatic coating liquid further includes: an auxiliary additive, wherein, based on a total weight of the antistatic coating liquid being 100 wt %, the auxiliary additive ranges between 0.05 wt % and 10 wt %; wherein the auxiliary additive is at least one of a dispersant, an anti-foaming agent, and a wetting agent.

6. The antistatic polyester film according to claim 1, wherein the conductive additive is at least one of a conductive polymer and a carbon nanotube.

7. The antistatic polyester film according to claim 1, wherein the polyester substrate includes a first polyester resin layer and two second polyester resin layers; wherein the first polyester resin layer includes a polyester resin and inorganic particles; wherein, based on a total weight of the first polyester resin layer being 100 wt %, the polyester resin ranges between 50 wt % and 95 wt %, and the inorganic particles range between 5 wt % and 50 wt %.

8. The antistatic polyester film according to claim 7, wherein the first polyester resin layer has two surfaces opposite to each other, the two second polyester resin layers are respectively formed on the two surfaces of the first polyester resin layer, and each of the second polyester resin layer includes a polyester resin and inorganic particles; wherein, based on a total weight of the second polyester resin layer being 100 wt %, the polyester resin ranges between 50 wt % and 95 wt %, the inorganic particles range between 5 wt % and 50 wt %; wherein the antistatic coating layer is formed on a side surface of at least one of the second polyester resin layers that is away from the first polyester layer.

9. The antistatic polyester film according to claim 8, wherein, after extension, the first polyester resin layer has a thickness between 50 μm and 300 μm, and each of the second polyester resin layer has a thickness between 1 μm and 50 μm.

10. An antistatic coating liquid, comprising:
an aqueous solvent ranging between 50 wt % and 85 wt % in content, based on a total weight of the antistatic coating liquid;
a conductive additive ranging between 1 wt % and 20 wt % in content, based on a total weight of the antistatic coating liquid; and
a water soluble polyester resin ranging between 2 wt % and 40 wt % in content, based on a total weight of the antistatic coating liquid.
